(19) United States
(12) Patent Application Publication
(10) Pub. No.: US 2024/0199330 A1
(43) Pub. Date: Jun. 20, 2024

(54) A SYSTEM AND A TRANSPORT DEVICE THEREFOR

(71) Applicant: Ocado Innovation Limited, Hatfield, Hertfordshire (GB)

(72) Inventors: David SHARP, Hatfield, Hertfordshire (GB); Joseph ZAMMIT, Hatfield, Hertfordshire (GB); Sean CLARK, Hatfield, Hertfordshire (GB); Benjamin THOMAS, Hatfield, Hertfordshire (GB); Adam LANCASTER, Hatfield, Hertfordshire (GB)

(73) Assignee: Ocado Innovation Limited, Hatfield, Hertfordshire (GB)

(21) Appl. No.: 18/555,013

(22) PCT Filed: Apr. 22, 2022
(86) PCT No.: PCT/EP2022/060667

§ 371 Date: Oct. 12, 2023

(30) Foreign Application Priority Data
Apr. 22, 2021 (GB) 2105751.8

(51) Int. Cl. B65G 1/10; B65G 1/04

(52) U.S. Cl. CPC B65G 1/10; B65G 1/0478

(57) ABSTRACT

This disclosure relates to a system having a first transport device including one of a guide and/or drive connected to a surface of a second transport device, having another guide and/or drive. The drive is configured to interact with the guide to effect movement of one of the first or second transport device relative to the other of the first or second transport device. The guide is configured to change between an active state, in which it is securely engaged with the drive means to effect movement of one of the first or second transport device, and a passive state in which the drive is not engaged, allowing the first and second transport devices to be separated.

The present disclosure relates generally to the field of robotic storage systems and more specifically to transport and storage devices which are arranged to form a cluster with a reconfigurable physical topology.

### BACKGROUND

Some commercial and industrial activities require systems which enable the storage and retrieval of a large number items which may be stored in containers. Methods of handling containers stacked in rows have been well known for decades. In some such systems, for example as disclosed in U.S. Pat. No. 2,701,065 (Bertel), freestanding stacks of containers are arranged in rows in order to reduce the storage volume associated with storing such containers, but yet still providing access to a specific container if required. Access to a given container is made possible by providing relatively complicated hoisting mechanisms that can be used to stack and remove given containers from stacks. The costs of such systems are, however, impractical in many situations and they have mainly been commercialised for the storage and handling of large shipping containers.

The concept of using freestanding stacks of containers and providing a mechanism to retrieve and store specific containers has been developed further, for example as disclosed in European patent no. 0 767 113 (Cimcorp). This document discloses a mechanism for removing a plurality of stacked containers, using a robotic load handler in the form of a rectangular tube that is lowered around the stack of containers, and which is configured to be able to grip a container at any level in the stack. In this way, several containers can be lifted at once from a stack. The rectangular tube can be used to move several containers from the top of one stack to the top of another stack, or to move containers from a stack to an external location and vice versa. Such systems can be particularly useful where all of the containers in a single stack contain the same product. Such stacks are known as a single-product stacks. In the system disclosed in European patent no. 0 767 113, the height of the tube has to be at least as high as the height of the largest stack of containers, so that the highest stack of containers can be extracted in a single operation. Accordingly, when used in an enclosed space such as a warehouse, the maximum height of the stacks is restricted by the need to accommodate the tube of the robotic load handler above the stack.

One known type of system for the storage and retrieval of items in multiple product lines involves arranging storage bins or containers in stacks on top of one another, the stacks being arranged in rows. The storage bins are removed from the stacks and accessed from above by robotic load handling devices, removing the need for aisles between the rows and allowing more containers to be stored in a given space.

European patent no. 1 037 828 (Autostore) discloses a system in which stacks of containers are arranged within a frame structure. Robotic load handling devices can be controllably moved around the stack on a system of tracks on the uppermost surface of the stack. Other forms of robotic load handling device are further disclosed in, for example, Norwegian patent no. 3 173 66.

UK patent publication no. 2 520 104 (Ocado Innovation Limited) discloses a robotic load handling device where each robotic load handler only covers one grid space, thus allowing higher density of robotic load handlers and thus higher throughput of a given size system. However, any suitable form of load handling device can be used.

However, each of the known robotic storage systems described above possess one or more of the following drawbacks. In all examples, a peripheral frame structure is required above/around the stacks of storage bins. The frame structure supports robotic load handlers traversing on top of the frame structure above the stacks of storage bins. The use of such a frame structure reduces the density at which storage bins may be stored because space is consumed by the frame structure. Moreover, such a frame structure isn't dynamically scalable because the frame structure must be constructed to accommodate the maximum anticipated capacity, even if such capacity is uncertain or in the far future.

Additionally, the robotic load handlers also have to “dig” down into a stack of storage bins in order to retrieve a selected storage bin, which represents a time and energy overhead when retrieving a storage bin. It also follows that the systems described above require robotic load handlers, which represent an additional cost of the system.

Furthermore, when coordinating such a system, positive progress by a robotic load handler from a start location to a destination location typically requires the robotic load handler to undertake a number of unnecessary, unproductive and/or costly steps, such as avoiding other robotic load handling devices using route planning and/or collision avoidance. Also, when a storage bin becomes stuck in a stack of storage bins, it is difficult to recover storage bins beneath the stuck storage bin. Similarly, when a robotic load handler breaks down, access to storage bins below the robotic load handler is restricted until the robotic load handler is removed from its location above the stack of storage bins. Additionally, it may be difficult to recover a robotic load handler when it breaks down.

It is against this background that the invention was devised.

### SUMMARY

Accordingly, there is provided, in a first aspect, a system comprising one or more transport devices arranged in a cluster, the system comprising one of a guide means or a drive means connected to, that is to say associated with, a surface and a first transport device adjacent to the surface and comprising the other of the guide means or drive means, the drive means being configured to interact with the guide means to effect movement of one of the first transport device or the surface relative to the other of the first transport device or the surface, wherein the guide means is configured to change between an active state in which it is securely engaged with the drive means to effect movement of the first transport device or the surface and a passive state in which the drive means is not engaged, allowing the first transport device and the surface to be separated.

Optionally, the first transport device comprises the drive means and the surface comprises the guide means and wherein the surface forms part of a second transport device.

Optionally, the first transport device further comprises a guide means configured to interact with a drive means of an adjacent transport device to direct movement of the first transport device or the adjacent transport device within the cluster.

Optionally, the second transport device further comprises a drive means for moving the second transport device or an adjacent transport device within the cluster.

Optionally, each transport device of the plurality of transport devices has a cuboid shape, and wherein a drive means is provided on two adjacent side facets and a guide means is provided on the remaining two adjacent side facets.

Optionally, each transport device of the plurality of transport devices is positioned within the cluster in the same orientation such that at least one side facet associated with a drive means of any one transport device which has at least one neighbouring transport device opposes a side facet associated with a guide means of a neighbouring transport device.

Optionally, the guide means comprises a retaining means to maintain the engagement between the guide and drive means whilst the guide means in the active state.

Optionally, the guide means is configured to be held in one of at least a first or second position when in the active state, the first and second positions being arranged to direct movement of the first transport device or the surface through the cluster in a first and second direction respectively.

Optionally, the first direction is substantially orthogonal with respect to the second direction.

Optionally, the drive means of the first transport device is arranged to rotatably engage the guide means of the second transport device.

Optionally, the guide means comprises a rack and the drive means comprises a pinion configured to engage the rack.

Optionally, the rack is moveable so as to move the guide means between the active and passive states.

Optionally, the rack is rotatable about a rotational axis parallel to the axis about which the pinion rotates.

Optionally, the rotational axes of the rack and pinion are offset with respect to each other.

Optionally, the rotational axis of the rack is located on a vertex of a notional square circumscribing the outer circumference of the pinion.

Optionally, the rack further comprises fixed sections extending in the first and second directions.

Optionally, the retaining means comprises two walls positioned either side of the rack defining a channel into which the pinion is received when the guide means is in the active state.

Optionally, each transport device of the plurality of transport devices comprises a vertical alignment means for aligning itself with respect to a neighbouring transport device within its vertical neighbourhood.

Optionally, the vertical alignment means comprises a recessed area formed in the top facet and a retractable post extending from the bottom facet, the recessed area of any one transport device being configured to receive the retractable post of an upper neighbouring transport device so as to ensure the vertical alignment of the transport devices.

Optionally, at least one transport device comprises a greater or smaller volume when compared to the other transport devices.

Optionally, each transport device is individually addressable via one or more communication units.

Optionally, each transport device of the plurality of transport devices comprises a receiving space for holding inventory.

Optionally, the surface is fixed, for example, forming part of a wall or floor.

In a second aspect, there is provided a transport device for use in the system according to the first aspect.

In a third aspect, there is provided a plurality of transport devices arranged in a cluster comprising a first transport device comprising a drive means and a second transport device comprising a guide means, wherein the second transport device is adjacent to the first transport device and the drive means of the first transport device is configured to interact with the guide means of the second transport device to effect movement of one of the first or second transport devices relative to the other of the first or second transport devices, and wherein the guide means is configured to change between an active state in which it is brought into a secured engagement with the drive means of the first transport device to effect movement of the first or second transport device within the cluster and a passive state in which the drive means of the first transport device is not engaged, allowing the first and second transport devices to be separated.

### DRAWINGS

These and other aspects will now be described, by way of example only, and with reference to the accompanying drawings, in which;

FIG. 1 is a schematic perspective view of a storage system comprising a plurality of transport devices arranged in a cluster according to an embodiment of the invention;

FIGS. 2a to 2d show schematic perspective views of a transport device for use in the cluster of FIG. 1 in different rotational positions;

FIGS. 3a to 3c show schematic elevation views of a drive means and a guide means used in the transport device of FIG. 2 with the guide means being held at different rotational positions;

FIGS. 4a and 4b are schematic views showing the drive and guide means in engaged positions, and FIG. 4c shows the drive and guide means in a disengaged position;

FIGS. 5a to 5h show a series of schematic perspective views illustrating several steps involved in an example repositioning the transport device of FIG. 2 within the cluster of transport devices;

FIGS. 6a to 6f show a series of schematic side views of a cluster of transport devices illustrating several steps involved in moving the transport device of FIG. 2 horizontally through the cluster; and,

FIG. 7 is a schematic perspective view of a storage system according to a second embodiment of the invention.

In the figures, like features are denoted by like reference signs where appropriate.

### DETAILED DESCRIPTION

The following detailed description refers to the accompanying drawings that show specific details and examples of how the invention may be practiced. These examples are described in sufficient detail to enable those skilled in the art to practice the invention. Other examples may be utilised, and structural changes may be made without departing from the scope of the invention as defined in the appended claims. Moreover, direction references (including: upper, lower, upward, downward, left, right, leftward, rightward, top, bottom, side, above, below, front, middle, back, vertical, horizontal, height, depth, width, and any other terms having an implied orientation) are given by way of example to aid the reader's understanding of the particular examples described herein. They should not be read to be requirements or limitations, particularly as to the position, orientation, or use of the invention unless specifically set forth in appended claims. Similarly, connection references (e.g., attached, coupled, connected, joined, secured and the like) are to be construed broadly and may include intermediate members between a connection of elements and relative movement between elements. As such, connection references do not necessarily infer that two elements are directly connected and in fixed relation to each other, unless specifically set forth in the appended claims.

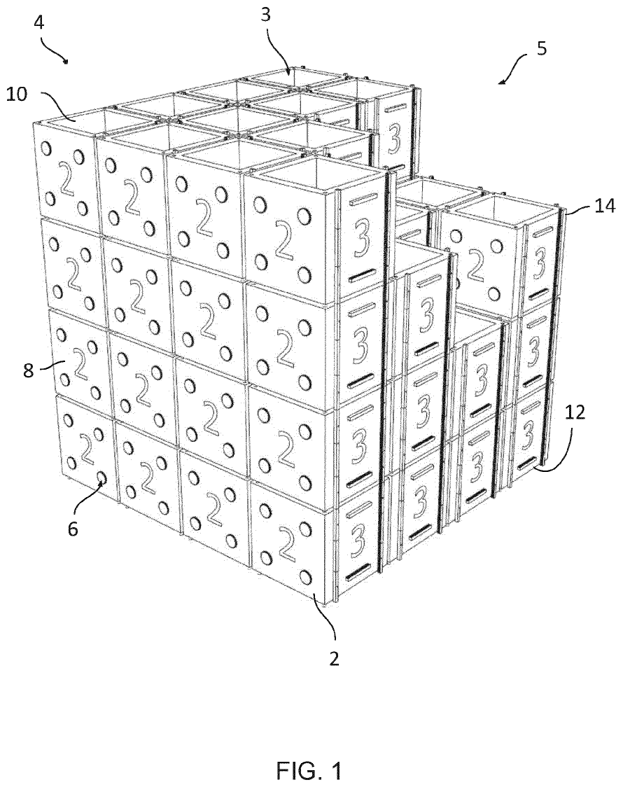

FIG. 1 is a perspective view of a cluster 4 of transport devices 2 arranged in a three-dimensional physical topology according to an embodiment of the invention. In this embodiment, the cluster 4 forms part of a storage and retrieval system 5, and the transport devices 2, which are tessellated so as to form a high density cluster 4, each comprise a receiving space 3 configured as a void for receiving an item. For example, the receiving space 3 may be arranged to hold products until they are to be packed and shipped as part of an order placed by a customer. Alternatively, the receiving space 3 may be arranged to contain items for an inventory system. In this regard, a cluster 4 is envisaged to comprise two or more transport devices 2 that are configured to cooperate together in a physical topology which may be rearranged by way of one transport device 2 relocating itself or being relocated, through interaction with another transport device 2 within the cluster 4. It will be noted that, in this embodiment, the cluster 4 comprises no external means that facilitates movement or relocation of the transport devices 2. Instead, advantageously, each transport device 2 comprises a mechanism by which, through cooperation with at least one other transport device 2, it is able to relocate itself within the cluster 4, altering the topology of the cluster 4. The cluster 4 may comprise an empty section, free of a transport device 2, which is used during the rearrangement of the cluster 4 to provide a location into which a transport device 2 may be moved, causing the empty section to relocate to the position now vacated by the moved transport device 2. However, such an empty space may not be required if the cluster 4 does not occupy the entire space in which the cluster 4 is operating. For example, the cluster 4 comprises stacks of transport devices 2. Each stack is located adjacent to another stack. The transport devices 2 in each stack may cooperate with one another to effect the movement of particular transport devices 2 in and around the cluster 4. As shown in FIG. 1, the stacks of transport devices 2 are of a variable height and indeed the number of stacks and the number of transport devices 2 in a stack may be variable and not limited to a particular number. Moreover, the cluster 4 may extend by any number of stacks and/or transport devices 2 in any of the x-direction, y-direction and/or z-direction. In the cluster 4 shown in FIG. 1, empty spaces are available for the movement of transport devices 2. For example, if the cluster 4 was in a location which could hold a maximum height of four transport devices 2, then the empty space is apparent because not every stack comprises four transport devices 2. In this example, four of the sixteen stacks comprise three transport devices 2 which is one fewer than the four transport devices 2 possible. Moreover, one stack comprises two transport devices 2. Therefore, empty spaces are available to accommodate the movement of a transport device 2.

It is envisaged that the cluster 4 may be of any size or shape and/or used in any type of environment. Moreover, the transport devices 2 forming the cluster 4 may be of a variety of sizes. For example, the transport devices 2 of differing widths, lengths and/or heights which are multiples of the width, lengths and/or heights (respectively) of the smallest transport device 2 in the cluster 4. Such a configuration may permit, for example, the storage and/or transportation of items which otherwise be too large or heavy for a smaller transport device 2 or due to reasons of energy- or space-efficiency.

As mentioned above, the cluster 4 has a reconfigurable topology, and each transport device 2 is arranged to interact with at least one other transport device 2 to provide a mechanism by which reconfiguration of the cluster 4 is achieved. Specifically, in this embodiment, each transport device 2 comprises a drive means, generally indicated by 6, for propelling the transport device 2 or a neighbouring transport device 2 within its horizontal neighbourhood. In this embodiment, the transport devices 2 are depicted as cuboids, each having four side facets 8, along with top and bottom facets 10, 12. Therefore, in this particular arrangement, each transport device 2 can have a maximum of four directly adjacent neighbouring transport devices 2 within its horizontal neighbourhood (hereinafter, “horizontal neighbouring transport devices 2”), and a maximum of two neighbouring transport devices 2 within its vertical neighbourhood (hereinafter, “vertical neighbouring transport devices 2”). Of course, a transport device 2 positioned on a corner of the cluster 4 may have up to two horizontal neighbouring transport devices 2, and up to one vertical neighbouring transport device 2 if it is also located in the top or bottom row of the cluster 4. It should be understood, however, that the transport device 2 need not have a cuboid shape, and that other embodiments are envisaged in which the transport devices 2 are shaped differently, such as an hexagonal shape, and/or sized differently.

In addition to the drive means 6, each transport device 2 further comprises a guide means 14 configured to interact with the drive means 6 of a horizontal neighbouring transport device 2 to direct the movement of the transport device 2 or the horizontal neighbouring transport device 2 within the cluster 4. The movement of the transport devices 2 is therefore performed without the use of an external or peripheral framework or external load handling robots. The guide means 14 is configured to move between an active state and a passive state. When in the active state, the guide means 14 is brought into a locked or secured engagement with the drive means 6 of the horizontal neighbouring transport device 2 to effect movement of the transport device 2 or the horizontal neighbouring transport device 2 within the cluster 4, and when in the passive state, the guide means 14 is prevented from engaging with the drive means 6 of the horizontal neighbouring transport device 2, allowing the transport device 2 and the horizontal neighbouring transport device 2 to be separated, for example, for removal from the cluster 4, to move one transport device 2 away from the other within the cluster 4 or to permit two transport devices 2 which start apart to come together, before moving into an engaged position.

Each transport device 2 further comprises one or more communication units (not shown) through which it is individually addressable. The addressability of each of the transport devices 2 is distinct from physically addressing the transport devices 2. Addressability is intended to refer to having an addressing scheme usable to send one or more instructions, for example motion control instructions, to individual transport devices 2 or groups of transport devices 2 in order to achieve translation of one or more transport devices 2 so as to relocate the one or more transport devices 2. In other words, the addressability of each transport device 2 (for the purposes of communication therewith) is independent of the location of the transport device 2 within the cluster 4. To this end, the one or more communication units are arranged to receive a control signal to control its corresponding transport device 2. For example, a communication unit of the one or more communication units may receive a signal indicating that the transport device 2 is to activate or deactivate. Additionally or alternatively, the signal may indicate a direction in the cluster 4 in which the transport device 2 is to move and/or a location within the cluster 4 in which the transport device 2 is to relocate itself. Additionally or alternatively, the signal may indicate that movement of the transport device 2 is to occur in a particular direction and by a certain distance, for example, a fraction of the height/width/depth of the transporting device or a multiple of the height/width/depth of the transport device 2. Accordingly, the one or more communication units may instruct their corresponding transport device 2, through interactions with its horizontal neighbouring transport device 2, to move in the direction indicated by the signal in order to relocate the transport device 2 within the cluster 4. Additionally or alternatively, the one or more communication units may instruct the movement of the horizontal neighbouring transport device 2, so that it may be relocated. In this way, individual transport devices 2 may relocate themselves within the cluster 4 based on a signal received by the one or more communication units. Additionally or alternatively, the one or more communication units may receive higher-level instructions which may be translated into one or more actuations, movements, communications or any other actions, for example reset or self-test instructions. The one or more communication units may be further arranged to transmit a signal to a controller of the storage and retrieval system 5. The signal may indicate the status of operation of its corresponding transport device 2, i.e., whether the operation has completed, is about to begin, its progress, additional information on the specific progress of the movement or other information. Moreover, the one or more communication units may indicate technical faults with its associated transport device 2 so that appropriate corrective actions may be taken.

With regard to the control of individual transport devices 2 within the cluster 4, a transport device 2 interacts or cooperates with at least one of its horizontal neighbouring transport devices 2 to effect the relocation of the transport device 2 or the horizontal neighbouring transport device 2 to an alternative location within the cluster 4, or to facilitate separation of the transport devices 2, for example, from the cluster 4. Such control strategies are addressed in WO2019/068778 A1 (in the name of Ocado Innovation Limited), the content of which is hereby being incorporated by reference.

In particular, the controller is arranged to determine a path for at least one of the transport devices 2 from a starting location to a destination location within the cluster 4. The controller may be further arranged to determine a control signal, based on the determined path, and transmit it to the one or more communication units, causing their associated transport device 2 to move in accordance with the determined path. In this way, the controller may, firstly, determine the path for a transport device 2 and, secondly, cause the transport device 2 to move along the determined path. Additionally or alternatively, the full path of a transport device 2 from a starting location to a destination location may not be determined in advance, but, instead, only one or more manoeuvres may be determined at the start of a relocation, or that the path is recalculated after the start of the relocation.

A path can be preferential for a number of reasons, including, but not limited to: least distance travelled, lower probability of encountering traffic, i.e., congestion, less total time required, lower probability of collision, less power used, ease of switching to alternate pathways, ability to avoid obstacles, for example a broken transport device 2, a broken path, and/or a part of the path that is under repair. The controller can use various algorithms to identify, design and/or control the movement of various transport devices 2 to which it is connected. The controller can be configured to optimise the movement of transport devices 2 through applying various algorithms to determine potentially advantageous routes from one location to another. The potential advantages can include shorter distance travelled, lower likelihood of encountering congestion, shorter time required, lower power consumption, coordination with movements of other transport devices 2, routing around obstacles such as broken transport devices 2 or broken areas of surface, or co-ordination with various workstation operations.

In addition to the above, the controller can be also configured to evaluate how to improve work allocations, movements of product and placement of product within the cluster 4 or to schedule when specific types of movements should happen, and in what order they should occur, depending on, for example, the application of various business rules and/or priority. The controller can be configured to determine both inbound and outbound factors in making decisions relative to, for example, product placement. For example, the controller can estimate delivery location of product supply, and estimate outbound delivery of product and move the transport devices 2 accordingly.

The controller can determine which of one or more transport devices 2 should be involved in the fulfilment of an order or for any other purpose. The action of the one or more transport devices 2 can typically require the transport devices 2 to traverse the cluster 4, and/or to conduct actions, such as support adjacent transport devices 2 and/or propel a given transport device 2. The controller can be configured to analyse various pathways in the cluster 4 to determine one or more paths that are potentially preferential relative to other pathways, given a set of constraints and conditions. These preferential pathways can be provided, one-time, periodically and/or dynamically to the transport devices 2 to control their movements throughout the cluster 4 and/or roles they perform within the cluster 4.

In some embodiments, the controller can be implemented using one or more servers, each containing one or more processors configured to perform one or more sets of instructions stored upon one or more non-transitory computer readable media. Potential advantages for computer implementation include, but are not limited to, scalability, ability to handle large amounts of processing and computational complexity, increased reaction speed, ability to make decisions quickly, ability to conduct complex statistical analysis, ability to conduct machine learning, among others. The controller may be implemented in any number of ways, for example, the controller may be implemented as a distributed computing system. For example, some or all of the functions of the controller may be distributed to the transport devices 2 themselves. Given respective destinations, one or more transport devices 2 may communicate with nearby transport devices 2 in the cluster 4 to coordinate movements in order for each of them to achieve their objective.

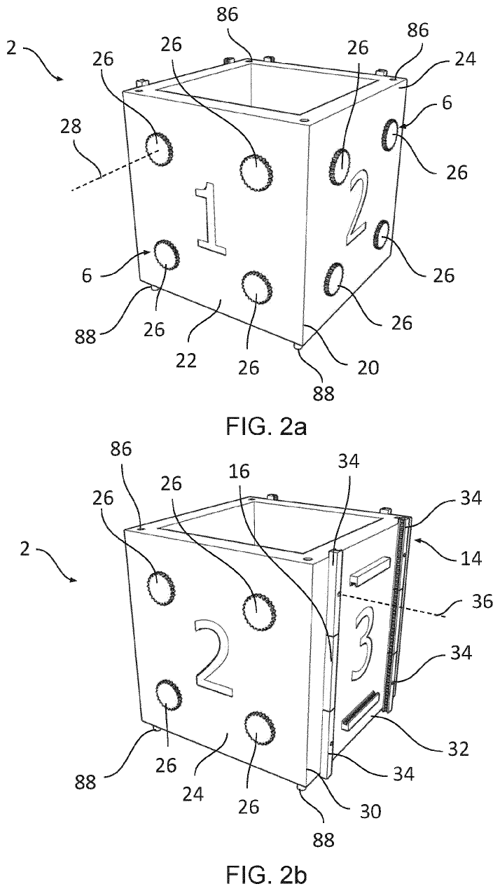

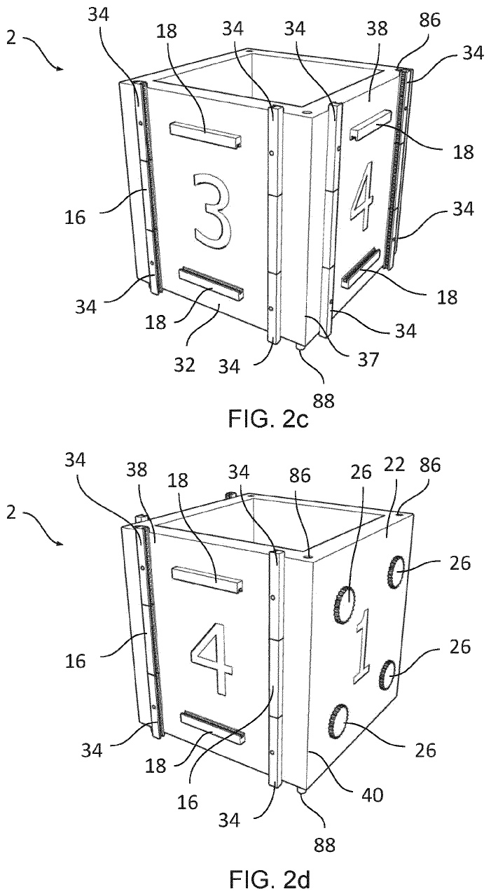

FIGS. 2a to 2d are a series of perspective views of a transport device 2 for use in the cluster 4 of FIG. 1 at different rotational positions. FIG. 2a shows a first vertical side edge 20 of the transport device 2, formed between adjacent first and second side facets 22, 24. Each of the side facets 22, 24 carries a drive means 6, which, in this embodiment, comprises a set of four pinions 26 arranged in a square formation, with each pinion 26 positioned at a vertex of the square formation. Each pinion 26 is operatively connected to an electric motor via a rotatable shaft, and is arranged to rotatably engage a guide means 14 of a horizontal neighbouring transport device 2. The electric motor is controlled by the one or more communication units in order that each pinion 26 is rotatable about a respective rotational axis 28 extending perpendicularly with respect to the side facet 22, 24 to which it is associated. An example of a guide means 14 is shown in FIG. 2b, in which a second vertical side edge 30 is shown. In this instance, the second vertical edge 30 is formed between the second side facet 24 and a third side facet 32, which is positioned adjacent to the second side facet 24 and carries a guide means 14. In this example, the guide means 14 comprises a set of four racks 34 that, similar to the pinions 26, are arranged in a square formation, with the centre point of each rack 34 positioned at a vertex of the square formation, so as to be engagable with a respective pinion 26 of a horizontal neighbouring transport device 2. Each rack 34 is operatively connected to an electric motor via a rotatable shaft. The electric motor is controlled by the communication unit so that each rack 34 is rotatable about a respective rotational axis 36 extending perpendicularly with respect to the third side facet 32 between an engaged position, in which it is brought into a locked engagement with a respective pinion 26 of a horizontal neighbouring transport device 2 to effect movement of the transport device 2 or the horizontal neighbouring transport device 2 within the cluster 4, and an unengaged position. In this way, the rotational axes 36 about which the racks 34 are rotatable are parallel to the rotational axes 28 of the pinions 26 on a horizontal neighbouring transport device 2. In this example, and in the example illustrated in FIG. 2c, which shows a third vertical side edge 37 formed between the third side facet 32 and a fourth side facet 38 that also carries a set of four racks 34, the racks 34 are held in a vertical engaged position and combine with a vertical fixed rack section 16 to form a vertical rack for directing vertical movement of the transport device 2 or the horizontal neighbouring transport device 2 within the cluster 4. The racks 34 may also be rotated to and held in a horizontal engaged position where they form, together with a horizontal fixed rack section 18, a horizontal rack for engaging with the pinions 26 of a horizontal neighbouring transport device 2 in order to direct horizontal movement of the transport device 2 or the neighbouring transport device 2 through the cluster 4. Finally, FIG. 2d shows a fourth vertical side edge 40 formed between the first and fourth side facets 22, 38. So, in this embodiment, a transport device 2 comprises a drive means 6 comprising two sets of four pinions 26, each set being provided on two adjacent side facets 22, 24, and a guide means 14, comprising two sets of four racks 34, each set being provided on the remaining two adjacent side facets 32, 38. For this particular arrangement, each transport device 2 is positioned within the cluster 4 in the same orientation such that at least one side facet 22, 24 associated with the drive means 6 of any one transport device 2 always opposes a side facet 32, 38 associated with the guide means 14 of a horizontal neighbouring transport device 2, so that any one transport device 2 is able to propel or be propelled by a horizontal neighbouring transport device 2 within the cluster 4.

As mentioned above, in general, the guide means 14 of a transport device 2 is configured to move between an engaged position, in which it is brought into a locked engagement with the drive means 6 of a horizontal neighbouring transport device 2, to effect movement of the transport device 2 or the horizontal neighbouring transport device 2 within the cluster 4, and an unengaged position, in which its engagement with the drive means 6 is prevented, allowing the transport device 2 and the neighbouring transport device 2 to be separated such that the transport device 2 or the horizontal neighbouring transport device 2 might be removed from the cluster 4 or separated from one another in the cluster 4. In this embodiment of the transport device 2, the engaged position comprises a first engaged position to effect vertical movement of the transport device 2 or the neighbouring transport device 2 and a second engaged position to effect horizontal movement of the transport device 2 or the neighbouring transport device 2.

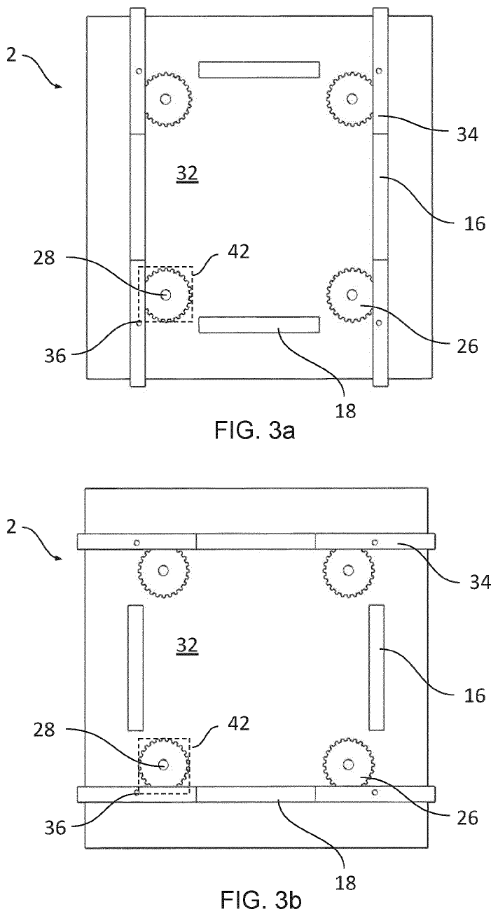

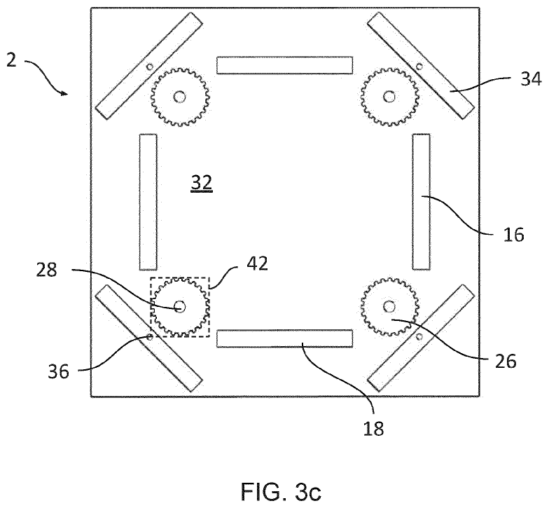

FIGS. 3a to 3c show the positional or spatial relationship between the guide means 14, i.e., the racks 34, of a transport device 2 and the drive means 6, i.e., the pinions 26, of a horizontal neighbouring transport device 2. It can be seen in these illustrations that the rotational axis 36 of the rack 34 and the rotational axis of the pinion 26 are offset with respect to each other, providing the requisite distance to enable the rack 34 to move between the engaged and unengaged positions. In this embodiment, the rotational axis 36 of the rack 34 is located on a vertex of a notional square 42 circumscribing the circumference of the pinion 26. Taking each figure in turn, FIG. 3a shows the racks 34 on the third side facet 32 of a transport device 2 in the first engaged position and in locked engagement with the pinions 26 on the first side facet 22 of a horizontal neighbouring transport device 2. When the racks 34 are in this position, rotation of the pinions 26 about their rotational axes 28 causes either the transport device 2 to which the racks 34 are associated with or the horizontal neighbouring transport device 2, to which the pinions 26 are associated with, to move vertically, either upwards or downwards depending on whether the pinions 26 are driven clockwise or counter clockwise. In order to effect a horizontal or sideways movement of the transport device 2 or the horizontal neighbouring transport device 2 within the cluster 4, the racks 34 are rotated about their rotational axis 36 from the first engaged position to the second engaged position as shown in FIG. 3b. From here, the pinions 26 can be driven about their rotational axes 28, causing either the transport device 2 to which the racks 34 are associated with or the horizontal neighbouring transport device 2 to which the pinions 26 are associated with to move sideways, either left or right, or forwards or backwards subject to one's perspective, depending on whether the pinions 26 are driven clockwise or counter clockwise. In addition to the two engaged positions, the rack 34 can also be driven about its rotational axis 36 to an unengaged position as shown in FIG. 3c. In this embodiment, the unengaged position is an angled position, generally midway between the first and second engaged positions, maximising the distance between respective pinions 26 and racks 34.

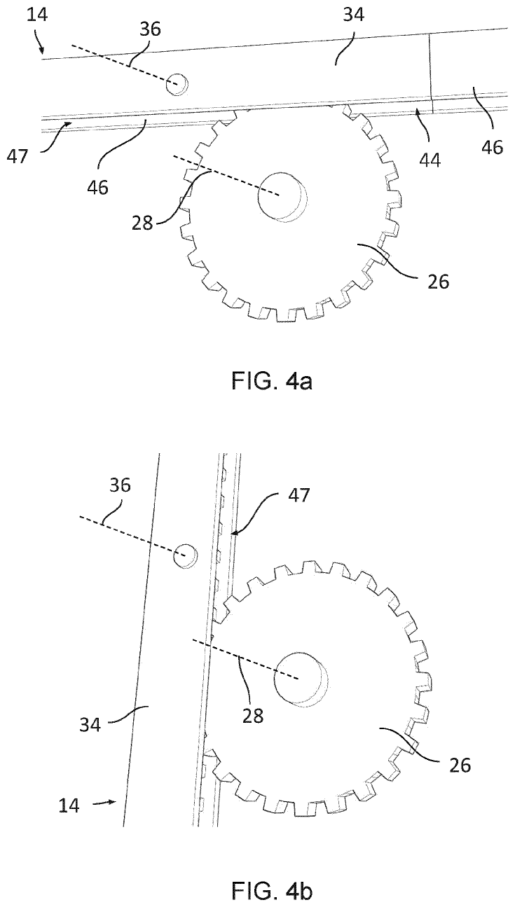

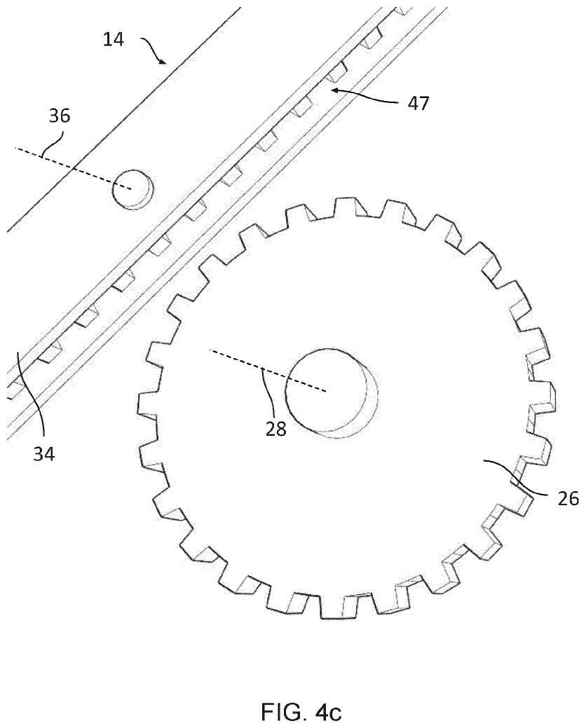

As mentioned above, when in the engaged position, the guide means 14 of one transport device 2 is brought into locked engagement with the drive means 6 of a horizontal neighbouring transport device 2. This means that the transport device 2 and the horizontal neighbouring transport device 2 cannot be separated by pulling one away from the other in the direction of the rotational axes 28, 36. In order to achieve this locked engagement, the guide means 14 comprises a retaining means 44 to maintain the engagement between the guide means 14 and the drive means 6 whilst the guide means 14 is in an engaged position. Turning to FIGS. 4a and 4b, in this embodiment in which the guide means 14 comprises a rack 34, the retaining means 44 comprises two walls 46 extending along the longitudinal edges of the rack 34 to define a channel 47 into which a pinion 26 is received when the rack 34 is in one of the first or second engaged positions. When the rack 34 is in one of these positions, any lateral movement of the pinion 26 is limited by the inner surfaces of the walls 46 acting on the planar surfaces of the pinion 26, preventing separation of the associated transport devices 2. When the rack 34 is moved to the unengaged or disengaged position, the channel 47 moves away from the pinion 26, as shown in FIG. 4c, and the associated transport devices 2 can be laterally separated.

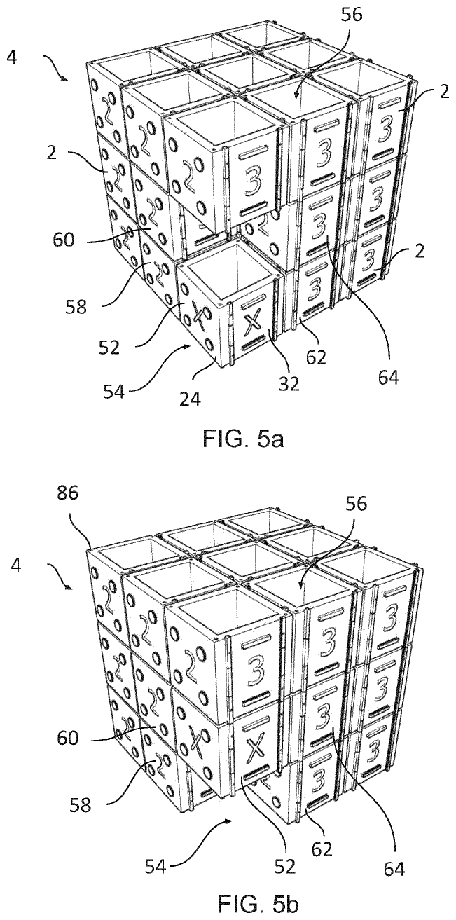

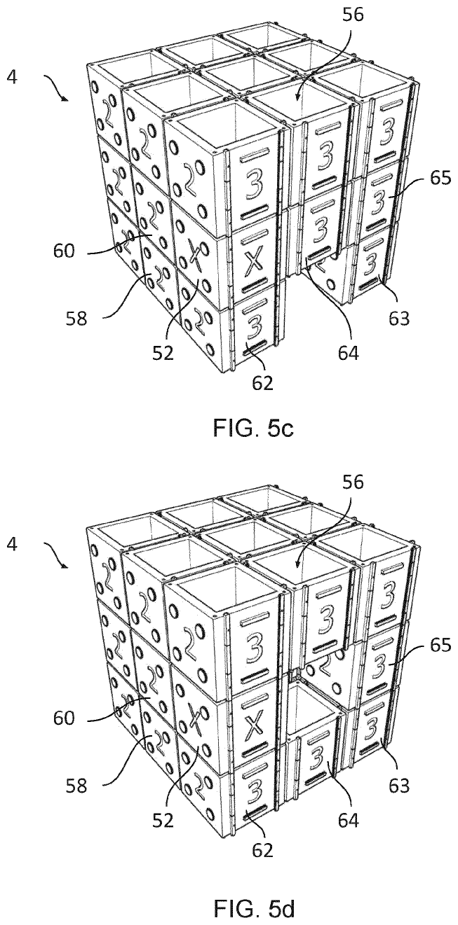

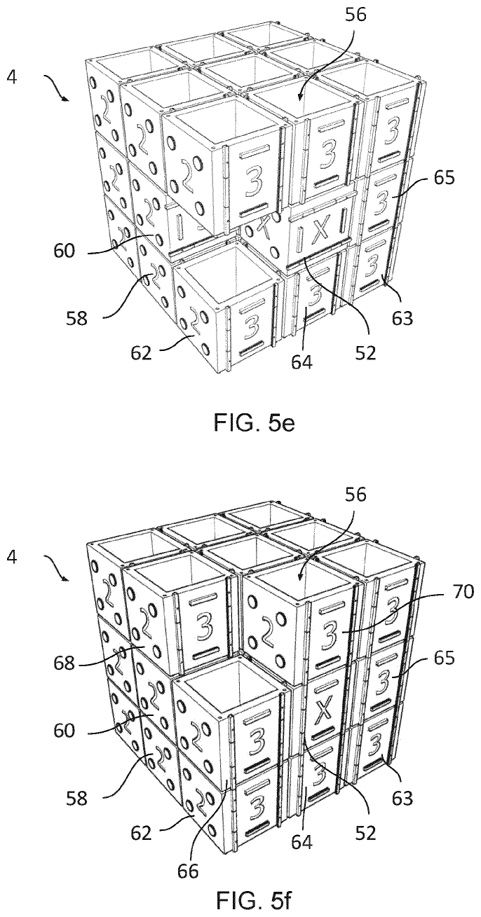

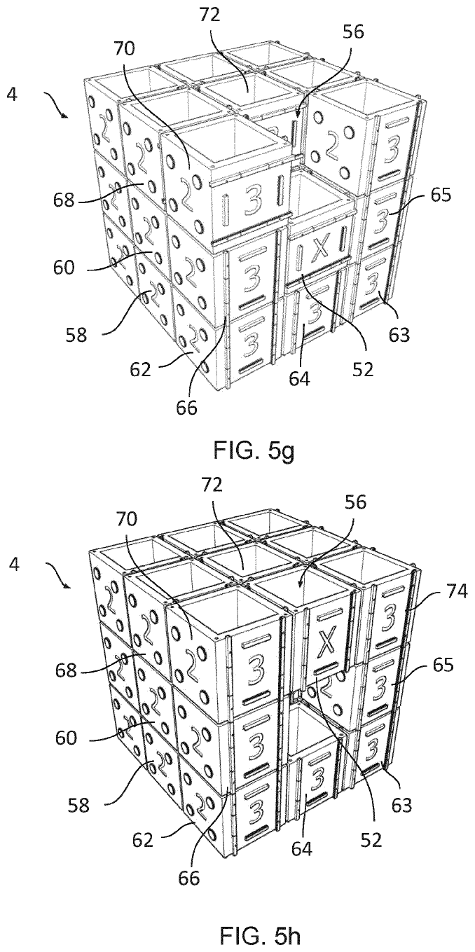

FIGS. 5a to 5h are a series of illustrations showing several steps involved in an example repositioning a target transport device 52 within the cluster 4. With reference to FIG. 5a, the target transport device 52 is orientated within the cluster 4 in the same position shown in FIG. 2b, such that only the second side facet 24, carrying the drive means 6, and the third side facet 32, carrying the guide means 14, can be seen. All of the other transport devices 2 forming the cluster 4 are similarly orientated. In this example, the starting location 54 of the target transport device 52 is a bottom corner of a cluster 4 and the destination location 56 is at the top of a central column of transport devices 2, and a single free space is provided within the cluster 4, immediately above the target transport device 52.

With reference to FIG. 5b, in a first step, the target transport device 52 is moved upwards to occupy the free space within the cluster 4 and create a new free space in the bottom corner of the cluster 4, at the starting location 54. This movement of the target transport device 52 is achieved by moving the racks 34 on the third side facet 32 (not shown) of a first horizontal neighbouring transport device 58 and the transport device 60 immediately above it to the first engaged position, forming a substantially continuous rack extending vertically along the combined height of the transport devices 58, 60, and the set of pinions 26 on the first side facet 22 (not shown) of the target transport device 52 are rotatably driven to move it upwards. Concurrently, the racks 34 on the fourth side facet 38 (not shown) of the target transport device 52 are also held in the first engaged position, and the set of pinions 26 on the second side facet 24 of a second horizontal neighbouring transport device 62 and the transport device 64 immediately above it are rotatably driven to move the target transport device 52 upwards.

From here, the transport device 62, that was previously a horizontal neighbour of the target transport device 52, is moved sideways to occupy the free space through the interaction between the set of pinions 26 on its first side facet 22 (not shown) and the racks 34 on the third side facets 32 (not shown) of its horizontal neighbouring transport devices, with transport device 58 becoming one of the horizontal neighbouring transport devices during transit of the transport device 62 to the free space (see FIG. 5c). Prior to this movement, the set of racks 34 on the fourth side facet 38 of transport device 62 are moved to the break away or disengaged position, preventing engagement with the set of pinions 26 on the second side facet 24 of transport device 63 and thereby enabling separation the transport devices 62, 63. Transport device 64 is then driven downwards, to create a free space adjacent to the target transport device 52, through the interaction between the sets of pinions 26 and racks 34 on its adjacent side facets. Firstly, the set of pinions 26 on the second side facet 24 (not shown) of transport device 64 and the set of racks 34, which are held in the first engaged position, on the fourth side facet 38 (not shown) of the target transport device 52 and transport device 62 (see FIG. 5d) are used for this downward movement. Concurrently, the set of racks 34 on the fourth side facet 38 of transport device 64 are also held in the first engaged position to engage the sets of pinions 26 on the second side facets 24 of the transport device 63, 65, which are then driven appropriately. At the same time, the set of pinions 26 on the first side facet 22 of transport device 64 are appropriately driven along the set of racks 34 held in the first engaged position on the third side facets 32 of the centrally located transport devices (not shown).

From here, the target transport device 52 is driven sideways to occupy the free space, as shown in FIG. 5e. This is done through interactions between the set of pinions 26 on the first side facet 22 (not shown) of the target transport device 52 and the racks 34 on the third side facets 32 (not shown) of its horizontal neighbouring transport devices, of which transport device 60 is one. Specifically, the sets of racks 34 are held in the second engaged position, forming, together with the horizontal fixed rack sections 18, a substantially continuous horizontal rack 34 extending along the combined length of the horizontal neighbouring transport devices, and the pinions 26 on the first side facet 22 (not shown) of the target transport device 52 are rotatably driven to move the target transport device 52 sideways, into the free space. Additionally, prior to arrival in its new position adjacent to transport device 65, the racks of the fourth side facet 38 of target transport device 52 are moved to the break away or disengaged position. Once in the correct position, the racks of the fourth side facet 38 of target transport device 52 are then moved to either the first or second engaged positions.

In the next step, as shown in FIG. 5f, transport device 66 is moved downwards to occupy the free space made available by the sideways movement of the target transport device 52. This movement is carried out through interactions between the set of pinions 26 on the first side facet 22 (not shown) of the transport device 66 and the set of racks 34, which are held in the first engaged position, on the third side facets 32 (not shown) of transport devices 60, 68, and through interactions between the set of racks 34 on the fourth side facet 38 (not shown) of the transport device 66 and the set of pinions 26 on the second side facets 24 of the target transport device 52 and the transport device 70 immediately above it.

Subsequently, transport device 70 is moved sideways to occupy the free space left by the downwards movement of transport device 66 through interactions between the set of pinions 26 on the first side facet 22 of the transport device 70 and the set of racks 34 on the third side facets 32 of transport device 68, 72, which are held in the second engaged position to form, along with the horizontal fixed rack sections 18, a substantially continuous rack 34 largely spanning the combined length of the transport devices 68, 72 (see FIG. 5g). Following this, in the final step, the target transport device 52 is moved upwards into the destination location 56, as shown in FIG. 5h. In this instance, the target transport device 52 has neighbouring transporting devices adjacent to its first, second and fourth side facets 22, 24, 38 and interacts with all of these neighbouring transport devices to complete its upward movement to the destination location 56. Specifically, the set of racks 34 on the fourth side facets 38 of transport devices 66, 70 are held in the first engaged position and the set of pinions 26 on the second side facet 24 of the target transport device 52 are rotatably driven, moving the target transport device 52 upwards. At the same time, the set of racks 34 on the other side of the target transport device 52, that is, the fourth side facet 38, are also held in the first engaged position and interact with the set of pinions 26 on the second side facets 24 of transport devices 65, 74, which are rotatably driven to move the target transport device 52 into the destination location. Finally, the set of racks 34 on the third side facets 32 of transport device 72 and the transport device immediately below it are also held in the first engaged position in order to interact with the set of pinions 26 on the first side facet 22 of the target transport device 52 so as to drive the target transport device 52 to the destination location 56. The above describes an example movement of an individual transport device 2 through the cluster 4, but, of course, one or more other transport devices 2 may be moved about the cluster 4 simultaneously. It is also possible to link two or more adjacent transport devices 2 through interactions between their drive means 6 and guide means 14, held in the first or second engaged position, to form a chain of transport devices 2 that can be moved through the cluster 4 as a group. Through interactions between appropriate sets of pinions and racks 26, 34, such a chain of transport devices 2 might move longitudinally or transversely through the cluster 4. Forming a chain of transport devices 2 is particularly useful for accessing transport devices 2 within the cluster 4 that have failed and can no longer contribute to propelling itself through the cluster 4.

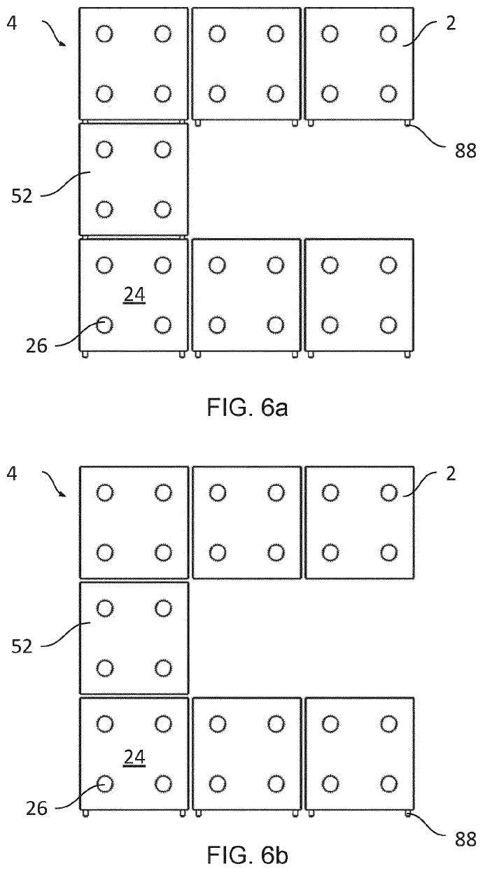

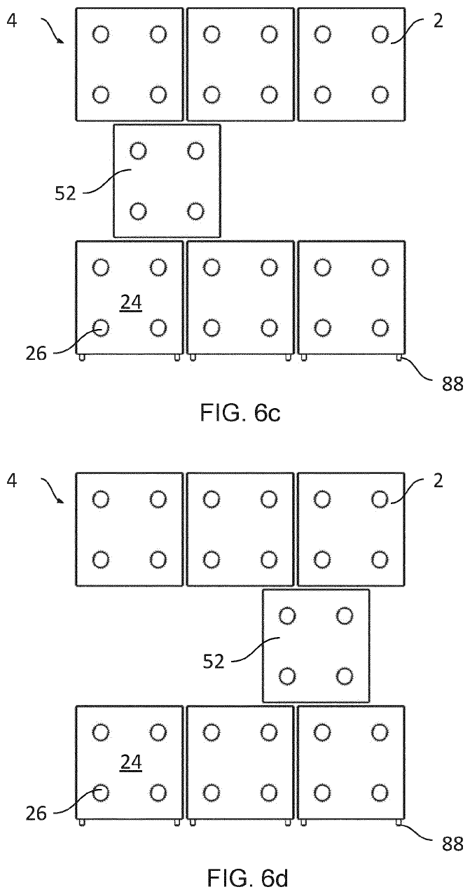

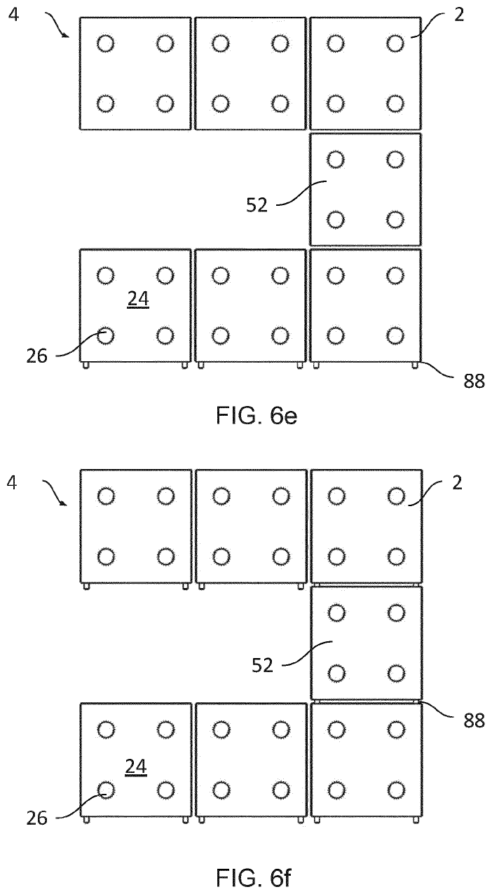

Although not discussed in relation to the preceding figures for reasons of simplicity, a vertical gap is required between rows of transport devices 2 to enable their horizontal movement through the cluster 4. To this end, the transport devices 2 generally comprise one or more recessed areas 86 formed in their top facet 10 and a corresponding number of retractable posts 88 extendable from their bottom facet 12. Specifically, the transport devices 2 of this embodiment, which have a cuboid shape, each comprise four recessed areas 86 and four corresponding retractable posts 88 (see FIGS. 2a to 2d). The recessed areas 86 and retractable posts 88 are spatially arranged so as to cooperate, meaning that a recessed area 86 of a first transport device 2 is configured to receive a retractable post 88 of a second transport device 2 positioned above it so as to support the second transport device 2 above the first transport device 2 and define a gap therebetween. The recessed areas 86 and retractable posts 88 therefore support transport devices 2 arranged in a stack and ensure their vertical alignment, as shown in FIG. 6a. In order that a target transport device 52 might be moved horizontally to a destination location, the row of transport devices 2 extending above a horizontal path along which the target transport device 52 is to be moved are held in position above the horizontal path. This is done by holding their guide means 14 and/or the guide means 14 of their horizontal neighbouring transport devices 2 into the first or second engaged position. Indeed, some of the guide means 14 of the transport devices and/or their horizontal neighbouring transport devices 2 may be held in the breakaway or disengaged position, provided that the row of transport devices 2 extending above the horizontal path is nonetheless adequately supported. In this way, the row of transport devices 2 are supported by their horizontal neighbouring transport device 2. The retractable posts 88 can then be retracted, although not necessarily simultaneously, by means of a suitable actuator controlled by the controller via the one or more communication units, so that they do not obstruct the target transport device 52 when it moves along the horizontal path. Similarly, the target transport device 52 is also supported by its horizontal neighbouring transport devices 2, through moving its guide means 14 and the guide means 14 of its horizontal neighbouring transport devices 2 into the second engaged position as it traverses the horizontal path, and its retractable posts 88 are then retracted so as not to impede its movement along the horizontal path, as shown in FIG. 6b The target transport device 52 is then driven along the horizontal path, by the operation of its drive means 6 and the drive means 6 of its horizontal neighbouring transport devices 2 as it traverses the horizontal path, to the destination location, as shown in FIGS. 6c to 6e. Once at the destination location, the retractable posts 88 of the transport devices 2 forming the stack that includes the target transport device 52 can be extended to support the transport devices 2, as shown in FIG. 6f In some examples, the retractable posts 88 may be used to transmit control signals and or power, for example, between the one or more communication units of different transport devices 2, and/or to power motors, actuators, etc.

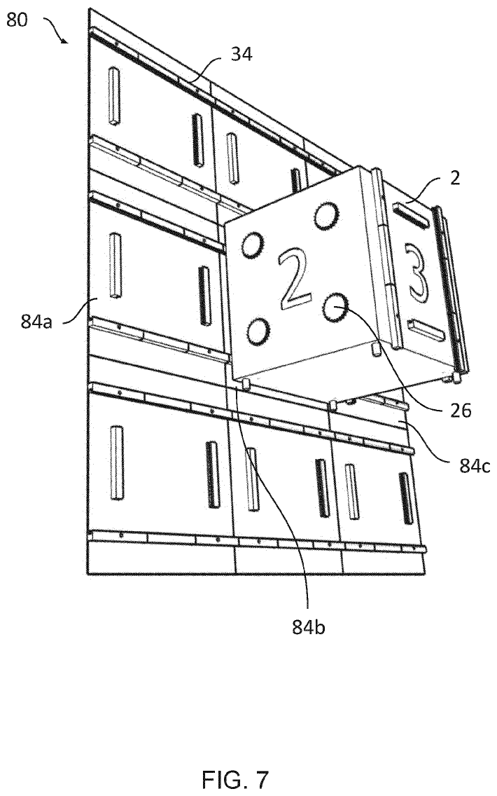

FIG. 7 depicts another system according to a second embodiment of the invention. Unlike the earlier embodiment, in which transport devices 2 cooperate to propel one or more transport devices 2 within the cluster 4, this embodiment comprises at least one transport device 2 located adjacent to a surface 80, which cooperate with each other to move one of the transport device 2 or surface 80 relative to the other of the transport device 2 or surface 80. In this particular example, it is the transport device 2 that moves relative to the surface 80, which is depicted as a wall. In essence, the surface 80 replicates the function of a horizontal neighbouring transport device 2 in the earlier embodiment. To that end, in this embodiment, the surface 80 comprises a guide means 14 and the transport device 2 comprises a drive means 6 associated with the facet of the transport device 2 facing the surface 80, i.e. the first side facet 22. However, the skilled reader will understand that the surface 80 might instead comprise a drive means 6, or a combination of a drive and guide means 6, 14. The drive means 6 is configured to interact with the guide means 14 to effect movement of the transport device 2 relative to the surface 80. The drive and guide means 6, 14 of this embodiment are the same as in the earlier embodiment in that they comprises sets of pinions 26 and racks 34 respectively that interact with each other to move one of the transport device 2 or surface 80 with respect to each other. The sets of racks 34 are moveable between an active state, in which it is securely engaged with a respective sets of pinions 26 to effect movement of the transport device 2 or the surface 80, and a passive state in which the drive means is not engaged, allowing the transport device 2 and the surface 80 to be separated. The surface 80 may comprise individual cells 84a, 84b, 84c where the transport device 2 cooperates with at least one cell at any moment. In this way, the transport device 2 may move from cell to cell across the surface 80. For example, the transport device 2 may be moved from cell 84a to cell 84b to reconfigure the physical topology of a cluster 4 comprising a plurality of transport devices 2. In this way, the transporting device 2 may be added to or removed from the cluster 4. Although shown as being adjacent to the transport device 2, the surface 80 may instead be arranged as a floor being underneath any facet of the transport device 2, provided that the facet carries one of a drive means 6 or a guide means 14 to complement the other of the drive or guide means 14 on the surface 80. The surface 80 may alternatively be positioned above the transport device 2. Moreover, more than one surface 80 may be used to move the transport device 2 in more than one dimension. For example, one surface may be arranged underneath the transport device 2 and another surface arranged on one side of the transport device 2 as a wall, permitting the movement of the transport device 2 in any orthogonal direction to change the position of the transport device 2.

The present disclosure describes examples of how the invention may be practiced, and it will be appreciated by those skilled in the art that a variety of approaches may be adopted without departing from the scope of the invention as defined by the appended claims.

For example, in some alternative embodiments, all of the facets of the transport devices 2 might be solid such that the transport devices 2 not include a receiving space 3. A system using this type of transport devices 2 may be reconfigurable so as to lift or support an object. Moreover, the example drive and guide means 6, 14 given in this disclosure comprise sets of four pinions 26 and racks 34 respectively. Examples are envisioned in which the drive and guide means 6, 14 include sets having a different number of pinions 26 and racks 34. In some of these examples, each set of pinions 26 may include more pinions 26 when compared to the number of racks 34 in the set of racks 34. In this case the racks 34 would be sized and positioned to form a gap, allowing one or more of the pinions 26 to pass between the racks 34 during the relative movement between transport devices 2. The pinions 26 may not be associated with their own motor; motors may be linked together or the skilled person may appreciate that not all pinion wheels of a facet may need to be driven, but instead may be passive wheels. Moreover, each rack in a set of racks 34 might all have their own independent motor and control system, and this might be needed in order to facilitate a change in direction of movement of a transport device. For instance, when moving a transport device 2 that is supported only on one of its side facets and changing from a vertical to a horizontal direction, the transport device 2 may move the upper racks of the set of racks 34 first. Alternatively, it may move only one rack at the time, in order to sufficiently constrain the position and orientation of the transport device 2 relative to its horizontal neighbouring transport device 2. Peripherals also may be used with the cluster 4 to facilitate the addition or removal of transport devices 2 to or from the cluster 4. A conveying mechanism may be used onto which transport devices 2 may be located to be added to or removed from the cluster 4. Moreover, clusters 4 may be located in different locations for particular functions. For example, a first cluster could be located in a chilled environment whilst a second cluster could be located in an ambient environment. The first and second clusters may form the first and second levels of a larger cluster. In this way, the first cluster 4 may comprise transport devices 2 storing groceries which do not require chilling (such as dry goods) whilst the second cluster 4 may comprise transport devices 2 storing groceries which do require chilling (such as fresh produce). A customer's order could be fulfilled by extracting from the first and second clusters 4 those transport devices 2 comprising groceries which require chilling and groceries which do not require chilling which have been ordered by the customer. It will be appreciated that this description is provided by way of example only and groceries which may be chilled or stored at ambient temperatures may equally be stored in either the first or second cluster 4.

1. A system including one or more transport devices, the system comprising:
a first one of a guide means or a drive means connected to a surface; and
a first transport device adjacent to the surface and including an other of the guide means or drive means, the drive means being configured to interact with the guide means to effect movement of one of the first transport device or the surface relative to the other of the first transport device or the surface and
the guide means being configured to change between an active state in which it is securely engaged with the drive means to effect movement of the first transport device or the surface, and a passive state in which the drive means is not engaged, allowing the first transport device and the surface to be separated.

2. The system according to claim 1, wherein the first transport device comprises:
the drive means, and the surface comprises:
the guide means, and wherein the surface forms part of a second transport device.

3. The system according to claim 2, wherein the first transport device comprises:
a guide means configured to interact with a drive means of an adjacent transport device to direct movement of the first transport device or the adjacent transport device within a cluster.

4. The system according to claim 2, wherein the second transport device comprises:
a drive means for moving the second transport device or an adjacent transport device within a cluster.

5. The system according to claim 4, wherein each transport device of the plurality of transport devices has a cuboid shape, and wherein a drive means is provided on two adjacent side facets, and a guide means is provided on a remaining two adjacent side facets.

6. The system according to claim 5, wherein each transport device of the plurality of transport devices is positioned within the cluster in a same orientation such that at least one side facet associated with a drive means of any one transport device which has at least one neighbouring transport device opposes a side facet associated with a guide means of a neighbouring transport device.

7. The system according to claim 1, wherein the guide means comprises:
a retaining means to maintain engagement between the guide means and the drive means whilst the guide means in the active state.

8. The system according to claim 1, wherein the guide means is configured to be held in one of at least a first or second position when in the active state, the first and second positions being arranged to direct movement of the first transport device or the surface through a cluster in a first and second direction respectively.

9. The system according to claim 8, wherein the first direction is substantially orthogonal with respect to the second direction.

10. The system according to claim 2, wherein the drive means of the first transport device is configured and arranged to rotatably engage a guide means of the second transport device.

11. The system according to claim 10, wherein each guide means comprises:
a rack, and each drive means includes a pinion configured to engage the rack.

12. The system according to claim 11, wherein the rack is configured to be moveable so as to move the guide means between the active and passive states.

13. The system according to claim 12, wherein the rack is configured to be rotatable about a rotational axis parallel to an axis about which the pinion rotates.

14. The system according to claim 13, wherein the rotational axes of the rack and pinion are offset with respect to each other.

15. The system according to claim 14, wherein the rotational axis of the rack is located on a vertex of a notional square circumscribing a circumference of the pinion.

16. The system according to claim 15, wherein the rack comprises:
fixed sections extending in the first and second directions.

17. The system according to claim 15, comprising:
a retaining means to maintain engagement between the guide means and the drive means, and including two walls positioned either side of the rack defining a channel into which the pinion is received when the guide means is in the active state.

18. The system according to claim 1, wherein each transport device of the plurality of transport devices comprises:
a vertical alignment means for aligning itself with respect to a neighbouring transport device within its vertical neighbourhood.

19. The system according to claim 18, wherein the vertical alignment means comprises:
a recessed area formed in a top facet, and a retractable post extending from a bottom facet, the recessed area of any one transport device being configured to receive the retractable post of an upper neighbouring transport device so as to ensure vertical alignment of the transport devices.

20. The system according to claim 1, wherein at least one transport device of the plurality of transport devices comprises:
a greater or smaller volume when compared to other transport devices.

21. The system according to claim 1, wherein each transport device of the plurality of transport devices is configured to be individually addressable.

22. The system according to claim 1, wherein each transport device of the plurality of transport devices comprises:
a receiving space for holding inventory.

23. The system according to claim 1, wherein the surface is fixed.

24. A transport device comprising:
at least one of a first guide means or a first drive means configured for engaging with a second drive means or a second guide means of a surface, the first drive means or the first guide means being configured to effect movement of the first transport device relative to the surface; and
the first drive means and/or first guide means being configured to change between an active state in which it is securely engaged to effect movement of the first transport device, and a passive state in which the first transport device and the surface are separated.
